(19) United States
(12) Patent Application Publication
(10) Pub. No.: US 2010/0076759 A1
(43) Pub. Date: Mar. 25, 2010

(54) APPARATUS AND METHOD FOR RECOGNIZING A SPEECH

(75) Inventors: Yusuke Shinohara, Kanagawa-ken (JP); Masami Akamine, Kanagawa-ken (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/555,038

(22) Filed: Sep. 8, 2009

(30) Foreign Application Priority Data
Sep. 24, 2008 (JP) 2008-243885

(51) Int. Cl. G10L 15/20

(52) U.S. Cl. 704/233; 704/E15.04

(57) ABSTRACT

A noisy vector is extracted from a noisy speech, which is a clean speech on which a noise is superimposed. A noise parameter of the noise is estimated from the noisy vector. A prior distribution parameter of a clean vector of the clean speech is already stored. A joint Gaussian distribution parameter between the clean vector and the noisy vector is calculated by unscented transformation, from the noise parameter and the prior distribution parameter. A posterior distribution parameter of the clean vector is calculated by the joint Gaussian distribution parameter, from the noisy vector. By comparing the posterior distribution parameter with a standard pattern of each word previously stored, a word sequence of the noisy speech is output.

### CROSS-REFERENCE TO RELATED APPLICATIONS

This application is based upon and claims the benefit of priority from Japanese Patent Application No. 2008-243885, filed on Sep. 24, 2008; the entire contents of which are incorporated herein by reference.

### FIELD OF THE INVENTION

The present invention relates to a technique for recognizing a speech in a noisy environment.

### BACKGROUND OF THE INVENTION

In a noisy environment, speech recognition ability drops, which is a main problem related to a speech recognition system. As a method for improving a resistance for a noise in the speech recognition system, “a speech enhancement method” is proposed. As to the speech enhancement method, a clean speech is estimated from a noisy speech, which is the clean speech on which a noise is superimposed. Especially, a method for estimating the clean speech in a speech feature domain of the noisy speech is called as “a speech feature enhancement method” or “a feature enhancement method”.

The speech recognition apparatus to realize the feature enhancement method operates as follows. First, a feature vector of a noisy speech is extracted from the noisy speech on which a noise is superimposed. Next, a feature vector of a clean speech is estimated from the feature vector of the noisy speech. Last, by comparing the feature vector of the clean speech with a standard pattern of each word, a word sequence of the recognition result is output.

The feature enhancement method to which a property of joint Gaussian distribution is applied is disclosed in a following reference.

V. Stouten, H. Van hamme, and P. Wambacq, “Model-based feature enhancement with uncertainty decoding for noise robust ASR”, Speech Communication, vol. 48, pp. 1502-1514, 2006 . . . Reference 1

In this feature enhancement method, the feature vector of the clean speech and the feature vector of the noisy speech are assumed to be distributed as a joint Gaussian distribution, and a parameter of the joint Gaussian distribution is assumed to be known. In case of observing this feature vector of the noisy speech from an input speech signal, a posterior mean and a posterior covariance of the feature vector of the clean speech are calculated.

In this case, how to calculate the parameter of the joint Gaussian distribution is an important problem. A process in which quality of the feature vector drops by the noise has a nonlinearity. Accordingly, estimation of the parameter of the joint Gaussian distribution is a nonlinear estimation problem, which is not solved analytically.

In the reference 1, the nonlinear estimation problem is replaced with a linear estimation problem using the first-order Taylor approximation. By analyzing this linear estimation problem, the parameter of the joint Gaussian distribution is calculated. However, in the reference 1, a nonlinear function is linearly approximated by the first-order Taylor expansion, which causes a large approximation error. Accordingly, an accuracy to calculate the parameter of the joint Gaussian distribution is low. As a result, the speech recognition ability is not sufficiently high in the noisy environment.

### SUMMARY OF THE INVENTION

The present invention is directed to an apparatus and a method for stably recognizing a speech uttered in the noisy environment.

According to an aspect of the present invention, there is provided an apparatus for recognizing a speech, comprising: a feature extraction unit configured to extract a noisy vector from a noisy speech inputted, the noisy speech being a clean speech on which a noise is superimposed; a noise estimation unit configured to estimate a noise parameter of the noise from the noisy vector; a parameter storage unit configured to store a prior distribution parameter of a clean vector of the clean speech; a distribution calculation unit configured to calculate a joint Gaussian distribution parameter between the clean vector and the noisy vector by unscented transformation, from the noise parameter and the prior distribution parameter; a calculation execution unit configured to calculate a posterior distribution parameter of the clean vector by the joint Gaussian distribution parameter, from the noisy vector; and a comparison unit configured to compare the posterior distribution parameter with a standard pattern of each word previously stored, and output a word sequence of the noisy speech based on a comparison result.

### BRIEF DESCRIPTION OF THE DRAWINGS

FIG. 1 is a block diagram of a speech recognition apparatus of a first embodiment.

FIG. 2 is a block diagram of a feature enhancement unit in FIG. 1.

FIG. 3 is a flow chart of processing of the speech recognition apparatus in FIG. 1.

FIG. 4 is a block diagram of the speech recognition apparatus of a second embodiment.

FIG. 5 is a flow chart of processing of the speech recognition apparatus in FIG. 4.

FIG. 6 is a block diagram of the feature enhancement unit of a third embodiment.

FIG. 7 is a block diagram of a decision unit of the feature enhancement unit in FIG. 6.

FIG. 8 is a flow chart of processing of the speech recognition apparatus of the third embodiment.

FIG. 9 is a block diagram of the feature enhancement unit of a fourth embodiment.

FIG. 10 is a flow chart of processing of the speech recognition apparatus of the fourth embodiment.

### DETAILED DESCRIPTION OF THE EMBODIMENTS

Hereinafter, a speech recognition apparatus of various embodiments is explained.

### The First Embodiment

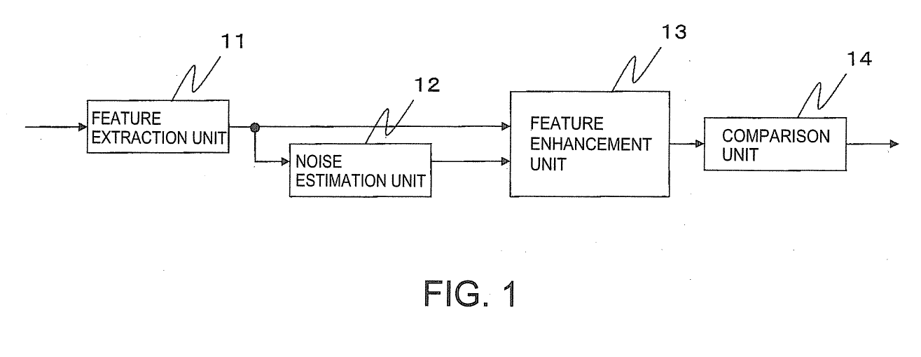

The speech recognition apparatus 10 of the first embodiment is explained by referring to FIGS. 1˜3. FIG. 1 is a block diagram of the speech recognition apparatus 10. As shown in FIG. 1, the speech recognition apparatus 10 includes a feature extraction unit 11, a noise estimation unit 12, a feature enhancement unit 13, and a comparison unit 14.

The feature extraction unit 11 is explained. The feature extraction unit 11 extracts a vector representing a speech feature from an input signal of a noisy speech. Concretely, the feature extraction unit 11 inputs a speech signal of the noisy speech. By slightly shifting a window on the speech signal in time series, the feature extraction unit 11 extracts a short period frame (Hereinafter, it is called “a frame”) from the speech signal. Next, the feature extraction unit 11 extracts a feature vector from each frame of the speech signal, and outputs the feature vector of a noisy signal in time series. As the feature vector, for example, a MFCC (Mel-Frequency Cepstral Coefficients) vector is used. In following explanation, a feature vector of the noisy speech (Hereinafter, it is called “a noisy vector”) is represented as “y”.

The noise estimation unit 12 is explained. As to each frame, the noise estimation unit 12 estimates a noise feature-distribution parameter (Hereinafter, it is called “a noise parameter”) of a noise feature vector from the noisy vector y. The noise parameter includes a mean (average) and a covariance of the noise feature vector. For example, feature vectors are extracted from a noise segment (noise period) not having a speech before an utterance, and a mean and a covariance are calculated from the feature vectors. Hereafter, on the assumption that a noise does not change during the utterance, the mean and the covariance calculated in this manner may be output from all frames during the utterance.

Furthermore, on the assumption that the noise changes during the utterance, whenever a segment not having a speech is extracted by a speech segment detector, the noise parameter may be updated using the feature vector of the segment. Hereinafter, a noise feature vector is represented as “n”. Furthermore, a noise parameter, i.e., a mean and a covariance of the noise feature vector, is represented as “μₙ” and “Σₙ” respectively.

The feature enhancement unit 13 is explained. The feature enhancement unit 13 calculates a clean speech feature-posterior distribution parameter (Hereinafter, it is called “a posterior distribution parameter”) of a clean speech feature vector (Hereinafter, it is called “a clean vector”), from the noisy vector y and the noise parameter. The posterior distribution parameter includes a posterior mean (average) and a posterior covariance of the clean vector given the noisy vector y. Hereinafter, the clean vector is represented as “x”. Furthermore, the posterior distribution parameter, i.e., the posterior mean and the posterior covariance of the clean vector x given the noisy vector y, is μ_{x|y} and Σ_{x|y} respectively. Detail of the feature enhancement unit 13 is explained afterwards.

The comparison unit 14 is explained. The comparison unit 14 compares the posterior distribution parameter of the clean vector x of each frame with a standard pattern of each word (previously stored), and outputs a word sequence of the noisy speech based on the comparison result. In this case, by using the posterior mean μ_{x|y} (calculated by the feature enhancement unit 13) as an estimated value of the clean vector x, the Viterbi decoding is normally executed. Furthermore, by using both the posterior mean μ_{x|y} and the posterior covariance Σ_{x|y}, the uncertainty decoding may be executed. The uncertainty decoding is disclosed in “L. Deng, J. Droppo, and A. Acero, “Dynamic compensation of HMM variances using the feature enhancement uncertainty computed from a parametric model of speech distortion”, IEEE Transactions on Speech and Audio Processing, vol. 13, no. 3, pp. 412, May 2005” . . . Reference 2.

By considering scale of the posterior covariance (uncertainty), the posterior distribution parameter of each frame is compared with the standard pattern. Accordingly, a frame having a large uncertainty (as an uncertain frame) has a small influence on the comparison. Conversely, a frame having a small uncertainty (as a certain frame) has a large influence on the comparison. As a result, speech recognition ability improves.

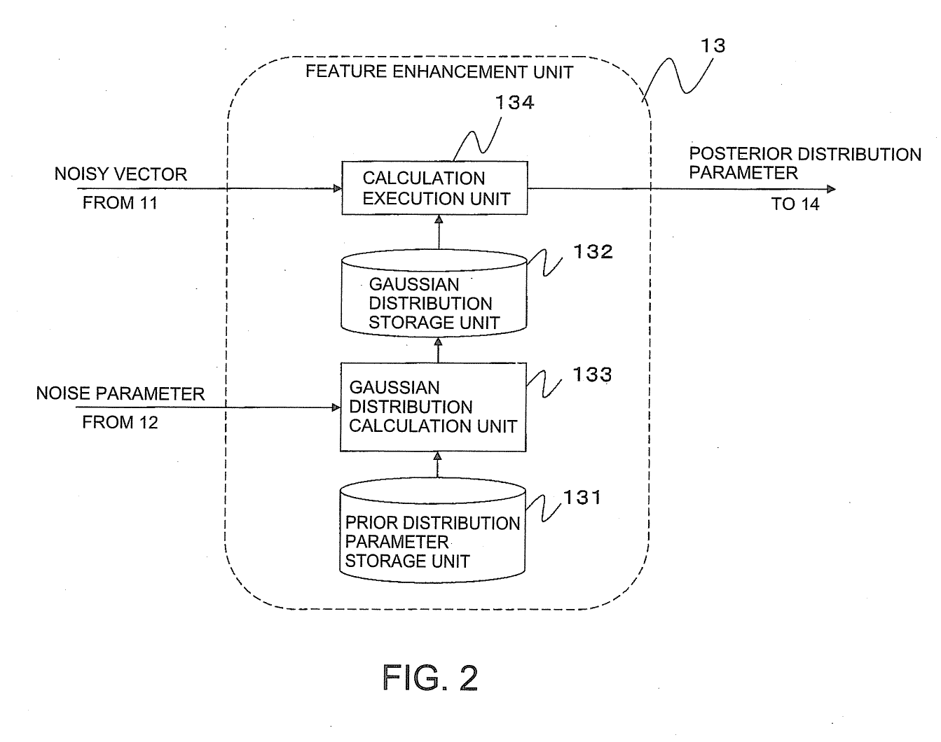

Next, detail of the feature enhancement unit 13 is explained by referring to FIG. 2. As shown in FIG. 2, the feature enhancement unit 13 includes a prior distribution parameter storage unit 131, a Gaussian distribution storage unit 132, a Gaussian distribution calculation unit 133, and a calculation execution unit 134.

The prior distribution parameter storage unit 131 is explained. The prior distribution parameter storage unit 131 stores a clean speech feature-prior distribution parameter (Hereinafter, it is called “a prior distribution parameter”) of the clean vector x. Concretely, a prior mean μₓ and a prior covariance Σₓ of the clean vector x are stored. The prior distribution parameter is previously calculated using a speech corpus recorded in a quite environment.

More concretely, the mean and the covariance are calculated using a set of feature vectors extracted from a corpus of a clean speech. If a speaker or a vocabulary is previously known, a corpus specific to the speaker or the vocabulary may be used. Furthermore, if the speaker or the vocabulary is not previously known, a corpus including various speakers or a broad vocabulary is preferably used.

The Gaussian distribution storage unit 132 is explained. The Gaussian distribution storage unit 132 stores a joint Gaussian distribution parameter (Hereinafter, it is called “a Gaussian parameter”) between the clean vector x and the noisy vector y. Briefly, the Gaussian distribution storage unit 132 stores a Gaussian parameter output from the Gaussian distribution calculation unit 133.

The Gaussian parameter includes a prior mean μₓ and a prior covariance Σₓ of the clean vector x, a mean μ_{y} and a prior covariance Σ_{y} of the noisy vector y, and a cross covariance Σ_{xy} between the clean vector x and the noisy vector y. By using the Gaussian parameter, the joint Gaussian distribution between the clean vector x and the noisy vector y is represented as an equation (1). In the equation (1), “N(μ, Σ)” represents a Gaussian distribution prescribed by the mean μ and the covariance Σ.

$$P ( x , y ) = N ( [ \begin{matrix}{μ}_{x} \\ {μ}_{y}\end{matrix} ] , [ \begin{matrix}{Σ}_{x} & {Σ}_{xy} \\ {Σ}_{xy}^{T} & {Σ}_{y}\end{matrix} ] ) \qquad ( 1 )$$

The Gaussian distribution calculation unit 133 is explained. The Gaussian distribution calculation unit 133 calculates a Gaussian parameter from the noise parameter and the prior distribution parameter by using the unscented transformation, and outputs the Gaussian parameter to the Gaussian distribution storage unit 132.

In this case, a nonlinear function “y=f(x,y)” to relate the clean vector x, the noise feature vector n and the noisy vector y, need to be already known. For example, in case of using MFCC vector as the feature vector, the nonlinear function is represented as an equation (2). In the equation (2), a matrix C represents a discrete cosine transform, an inverse matrix C⁻¹ represents an inverse discrete cosine transform, and “log” and “exp” operate each element of a vector.

y=f(x,n)=C log(exp(C⁻¹x)+exp(C⁻¹n)) (2)

In the prior art disclosed in the reference 1, the Gaussian parameter is calculated using the first-order Taylor approximation. However, in the present embodiment, the Gaussian parameter is calculated using the unscented transformation. Hereinafter, the prior art is explained in detail to point out the problem. After that, a method of the present embodiment is explained in detail.

As the prior art, the method for calculating the Gaussian parameter using the first-order Taylor approximation is explained. First, as shown in an equation (3), a nonlinear function of the equation (2) is approximated by the first-order Taylor expansion.

$$\begin{matrix}y = f ( x , n ) \\ \approx f ( {x}_{0} , {n}_{0} ) + F ( x - {x}_{0} ) + G ( n - {n}_{0} )\end{matrix} \qquad ( 3 )$$

In the equation (3), as shown in an equation (4), the nonlinear function f is partially differentiated by the clean vector x and the noise feature vector n respectively.

$$F = \frac{\partial f}{\partial x} , G = \frac{\partial f}{\partial n} \qquad ( 4 )$$

Furthermore, as shown in an equation (5), an expansion point (x₀,n₀) of Taylor expansion is set as a prior mean μₓ of the clean vector x and a mean μₙ of the noise feature vector n respectively.

x₀=μₓ, n₀=μₙ (5)

In this way, by approximating the nonlinear function with the first-order Taylor expansion, the Gaussian parameter is calculated by a linear operation. Briefly, a mean μ_{y} and a covariance Σ_{y} of the noisy vectory, a cross covariance Σ_{xy} between the clean vector x and the noisy vector y, are calculated by equations (6)˜(8) respectively.

μ_{y}=f(μₓ, μₙ) (6)

Σ_{y}=FΣₓF^{T}+GΣₙG^{T} (7)

Σ_{xy}=ΣₓF^{T} (8)

In the above-mentioned method of the prior art, in case of approximating the nonlinear function by the first-order Taylor expansion, approximation error occurs. By influence of the approximation error, an error to calculate the Gaussian parameter is large.

Next, a method for calculating the Gaussian parameter using the unscented transformation according to the present embodiment is explained. The unscented transformation is a method to accurately calculate a desired statistic in a nonlinear system. For example, the unscented transformation is disclosed in “S. Julier and J. Uhlmann, “Unscented filtering and nonlinear estimation”, Proceedings of the IEEE, vol. 92, no. 3, pp. 401-422, March 2004” . . . Reference 3.

The unscented transformation is explained. As to a first random variable x, a mean μₓ and a covariance Σₓ are already known. As to a second random variable n, a mean μₙ and a covariance Σₙ are already known. As to a third random variable y, the third random variable y is calculated from the first random variable x and the second random variable n by the known nonlinear function y=f(x,n). In this case, a problem to calculate a mean μ_{y} and a covariance Σ_{y} of the third random variable y, and a cross covariance Σ_{xy} between the first random variable x and the third random variable y, is considered. As a method for accurately solving this problem, the unscented transformation is known.

The Gaussian distribution calculation unit 133 calculates a Gaussian parameter by the unscented transformation. First, as shown in an equation (9), a vector “a” concatenating the clean vector x with the noise feature vector n is considered.

$$a = [ \begin{matrix}x \\ n\end{matrix} ] \qquad ( 9 )$$

In case that dimensions of the clean vector x and the noise feature vector n are Nₓ and Nₙ respectively, a dimension of the vector a is Nₐ (=Nₓ+Nₙ). A mean μₐ and a covariance Σₐ of the vector a are represented as equations (10) and (11) respectively.

$$\begin{matrix}{μ}_{a} = [ \begin{matrix}{μ}_{x} \\ {μ}_{n}\end{matrix} ] & ( 10 ) \\ {Σ}_{a} = [ \begin{matrix}{Σ}_{x} & o \\ o & {Σ}_{n}\end{matrix} ] & ( 11 )\end{matrix}$$

Next, a set of sample called as “sigma points” are generated. Briefly, Nₐ dimensional vector “aᵢ” of p units and a weight “wᵢ” associated with each vector are generated. As a method for generating the sigma point, various methods are well known. For example, they are disclosed in the reference 3. In this case, “a symmetric sigma point generation method” is explained. However, another sigma point generation method may be used.

As to the symmetric sigma point generation method, the vector aᵢ of p(=2Nₐ) units and the weight wᵢ associated with each vector are generated by an equation (12).

$${a}_{i} = {μ}_{a} + {( \sqrt{{N}_{a} {Σ}_{a}} )}_{i} \\ {w}_{i} = \frac{1}{2 {N}_{a}} \\ {a}_{i + Na} = {μ}_{a} - {( \sqrt{{N}_{a} {Σ}_{a}} )}_{i} \\ {w}_{i + Na} = \frac{1}{2 {N}_{a}} \\ ( i = 1 , … {N}_{a} ) \qquad ( 12 )$$

In the equation (12), a following element (13) represents the i-th column (or row) of a square root of a matrix NₐΣₐ.

(\sqrt{NₐΣₐ})ᵢ (13)

Next, as to each sigma point aᵢ of p units, the Gaussian distribution calculation unit 133 calculates yᵢ using a nonlinear function y=f(x,n). For example, in case that the feature vector is MFCC, the nonlinear function y=f(x,n) is represented as the equation (2). Furthermore, a vector corresponding to x of the i-th sample aᵢ is xᵢ. By using above-mentioned xᵢ and yᵢ (i=1, . . . ,p), the Gaussian parameter is calculated. Briefly, the Gaussian distribution calculation unit 133 calculates a mean μ_{y} and a covariance Σ_{y} of the noisy vector y, and a cross covariance Σ_{xy} between the clean vector x and the noisy vector y by equations (14)˜(16).

$$\begin{matrix}{μ}_{y} = {\sum }_{i = 1}^{p} {ω}_{i} {y}_{i} & ( 14 ) \\ {Σ}_{y} = {\sum }_{i = 1}^{p} {ω}_{i} ( {y}_{i} - {μ}_{y} ) {( {y}_{i} - {μ}_{y} )}^{T} & ( 15 ) \\ {Σ}_{xy} = {\sum }_{i = 1}^{p} {ω}_{i} ( {x}_{i} - {μ}_{x} ) {( {y}_{i} - {μ}_{y} )}^{T} & ( 16 )\end{matrix}$$

As mentioned-above, the Gaussian distribution calculation unit 133 calculates a Gaussian parameter from the prior distribution parameter and the noise parameter by the unscented transformation. In the prior art, a calculation error is large because the nonlinear function y=f(x,n) is approximated by the first-order Taylor expansion. However, in the present embodiment, the calculation error is small by using the unscented transformation.

The calculation execution unit 134 is explained. Based on the Gaussian parameter stored in the Gaussian distribution storage unit 132, the calculation execution unit 134 calculates a posterior distribution parameter of the clean vector from the noisy vector y. The posterior distribution parameter includes, as above-mentioned, a posterior mean μ_{x|y} and a posterior covariance Σ_{x|y}.

When two random variables x and y are distributed by the equation (1), as to a noisy vector y as a third random variable, a posterior mean and a posterior covariance of the clean vector x are calculated as an equation (17). The calculation execution unit 134 calculates a posterior distribution parameter using the equation (17).

$${μ}_{x \vert y} = {μ}_{x} + {Σ}_{xy} {Σ}_{y}^{- 1} ( y - {μ}_{y} ) \\ {Σ}_{x \vert y} = {Σ}_{x} - {Σ}_{xy} {Σ}_{y}^{- 1} {Σ}_{xy}^{T} \qquad ( 17 )$$

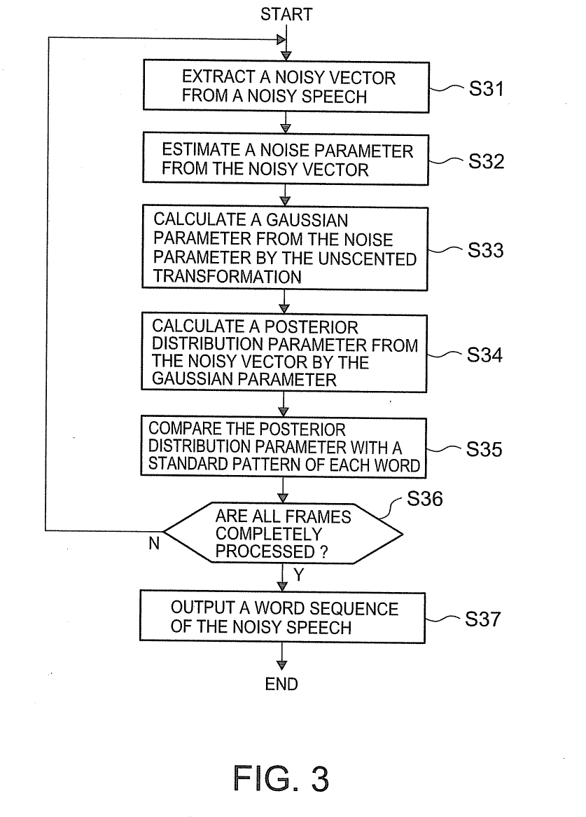

Next, processing of the speech recognition apparatus 10 of the present embodiment is explained by referring to FIG. 3. First, at S31, the feature extraction unit 11 calculates a noisy vector y from a frame of a speech. At S32, the noise estimation unit 12 estimates a noise parameter of a noise feature vector n from the noisy vector y. At S33, the Gaussian distribution calculation unit 133 calculates a Gaussian parameter from the noise parameter by the unscented transformation, and the Gaussian distribution storage unit 132 stores the Gaussian parameter. At S34, the calculation execution unit 134 calculates a posterior distribution parameter based on the Gaussian parameter stored in the Gaussian distribution storage unit 132. At S35, the comparison unit 14 compares the posterior distribution parameter of a clean vector x with a standard pattern of each word previously recorded. At S36, the speech recognition apparatus 10 decides whether all frames are completely processed. If at least one frame is not processed yet, next frame is processed at S31. If all frames are completely processed, at S37, the comparison unit 14 outputs a word sequence of the noisy speech based on the comparison result. As mentioned-above, in the first embodiment, the Gaussian parameter is accurately calculated by the unscented transformation. Accordingly, an effect to enhance the feature rises and an ability to recognize a speech is maintained in a noisy environment.

### The Second Embodiment

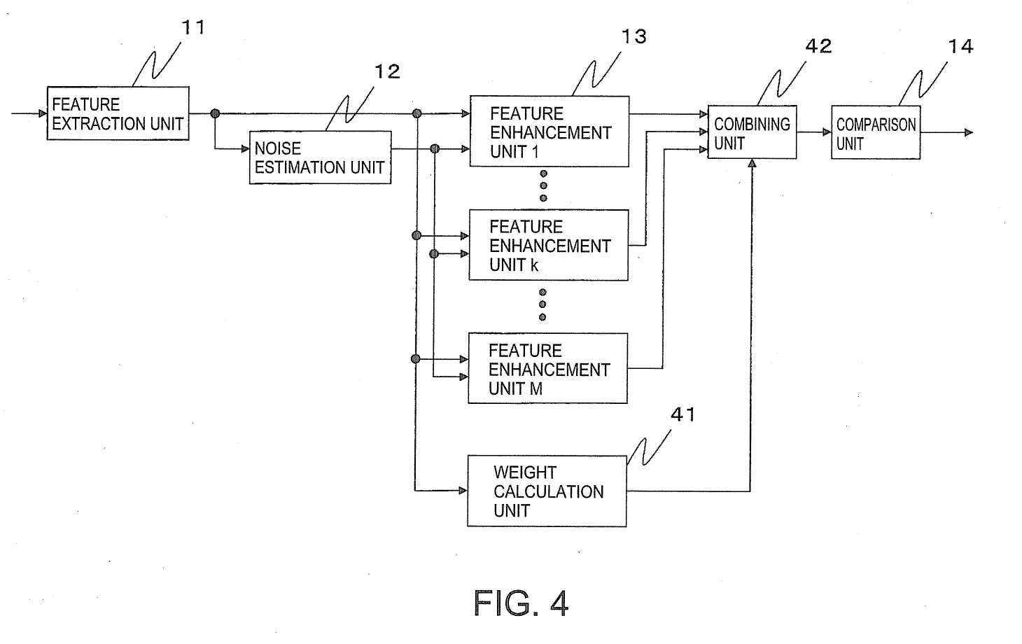

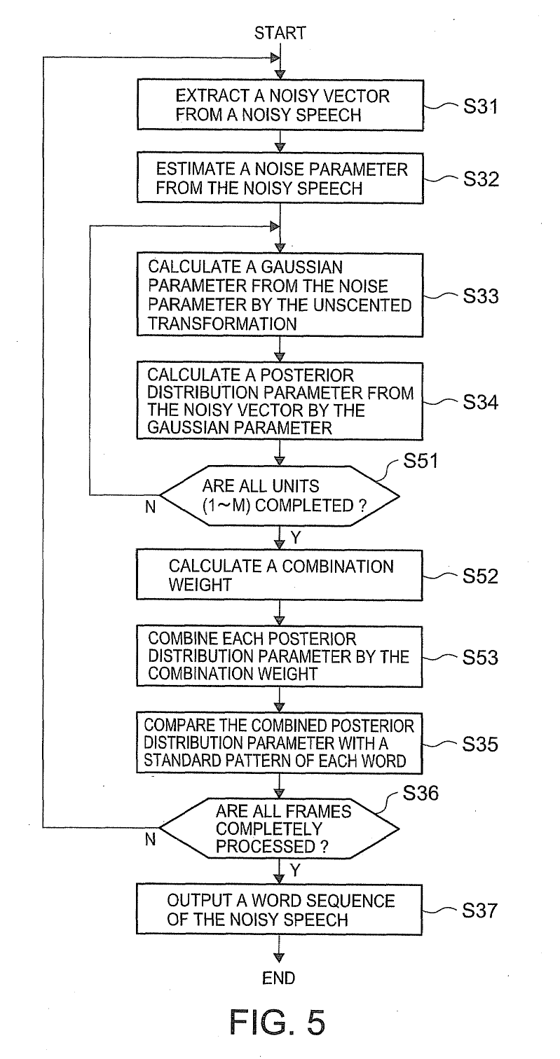

Next, the speech recognition apparatus 10 of the second embodiment is explained by referring to FIGS. 4 and 5. In the first embodiment, a prior distribution of the clean vector x is simply represented as a Gaussian distribution. Accordingly, the prior distribution cannot be often represented with full minuteness. In the second embodiment, the prior distribution of the clean vector x is represented as a Gaussian mixture model, and the prior distribution can be represented with higher minuteness. As a result, the feature is more effectively enhanced, and the ability to recognize a speech improves in the noisy environment.

First, the Gaussian mixture model to represent the prior distribution of the clean vector x, and a training method of the Gaussian mixture model, are explained. In the second embodiment, a feature enhancement unit 13 of M units (M>1) are prepared. A prior distribution p(x) of the clean vector x is represented by the Gaussian mixture model, as an equation (18).

$$p ( x ) = {\sum }_{k = 1}^{M} {π}_{k} N ( {μ}_{x}^{( k )} , {Σ}_{x}^{( k )} ) \qquad ( 18 )$$

In the equation (18), M is the number of mixture components (M>1), and k is a number of the feature enhancement units 13 (1<=k<=M). πₖ, μₓ^{(k)} and Σₓ^{(k)} are a mixture weight, a mean and a covariance of the Gaussian distribution of the k-th feature enhancement unit 13-k respectively. In the first embodiment, the prior distribution is simply represented as the Gaussian distribution. However, in the second embodiment, by using a plurality of Gaussian distributions mixed, the prior distribution can be represented with higher minuteness.

The Gaussian mixture model parameter to represent a prior distribution of the clean vector x is previously trained from a corpus of the clean speech and stored. Concretely, a set of feature vectors extracted from the corpus of the clean speech is used as training data, and the Gaussian mixture model parameter of the equation (18) is calculated by EM algorithm. Each feature enhancement unit 13 is, for example, generated in correspondence with each phoneme, and the feature enhancement unit 13 calculates a Gaussian parameter corresponding to its phoneme.

Next, component of the speech recognition apparatus 10 of the second embodiment is explained by referring to FIG. 4. FIG. 4 is a block diagram of the speech recognition apparatus 10. As shown in FIG. 4, the speech recognition apparatus 10 includes a feature extraction unit 11, a noise estimation unit 12, a feature enhancement unit 13-1, . . . 13-M of M units, a weight calculation unit 41, a combining unit 42, and a comparison unit 14. The feature extraction unit 11, the noise estimation unit 12 and the comparison unit 14 are same as those of the first embodiment, and its explanation is omitted.

The feature enhancement unit 13 is explained. The feature enhancement unit 13-1, . . . 13-M is same as that of the feature enhancement unit 13. However, a plurality of feature enhancement units is different from the first embodiment. Each feature enhancement unit 13-1, . . . 13-M has differently respective parameter. Briefly, a prior distribution parameter storage unit 131-k of the k-th feature enhancement unit 13-k stores the k-th Gaussian mixture model parameter μₓ^{(k)} and Σₓ^{(k)} of the Gaussian mixture model.

Furthermore, the Gaussian distribution calculation unit 133-k calculates a Gaussian parameter (μ_{y}^{(k)}, Σ_{y}^{(k)}, Σ_{xy}^{(k)}) from the noise parameter (μₙ, Σₙ) and the prior distribution parameter (μₓ^{(k)}, Σₓ^{(k)}), and stores them into the Gaussian distribution storage unit 132-k. The calculation execution unit 134-k calculates the k-th posterior distribution parameter, i.e., a posterior mean μ_{x|y}^{(k)} and a posterior covariance Σ_{x|y}^{(k)}, based on the Gaussian parameter stored in the Gaussian distribution storage unit 132-k.

The weight calculation unit 41 is explained. The weight calculation unit 41 calculates a weight to combine an output from the feature enhancement unit 13-1, . . . 13-M of M units. Briefly, based on the Gaussian parameter calculated by each Gaussian distribution calculation unit 133-k, the weight calculation unit 41 calculates a combination weight of each posterior distribution parameter for each frame.

Concretely, in case of observing a noisy vector y, a posterior probability p(k|y) that the present frame belongs to the feature enhancement unit 13-k is used as the combination weight. The posterior probability p(k|y) is calculated by an equation (19).

$$P ( k \vert y ) = \frac{{π}_{k} N ( y ; {μ}_{y}^{( k )} , {Σ}_{y}^{( k )}}{{Σ}_{{k}^{′}} N ( y ; {μ}_{y}^{( {k}^{′} )} , {Σ}_{y}^{( {k}^{′} )} )} \qquad ( 19 )$$

In the equation (19), πₖ is the mixture weight of the Gaussian mixture model, μ_{y}^{(k)} and Σ_{y}^{(k)} are referred as values stored in the Gaussian distribution storage unit 132-k of the k-th feature enhancement unit 13-k.

The combining unit 42 is explained. The combining unit 42 combines an output from the feature enhancement unit 13-1, . . . 13-M of M units. Concretely, outputs μ_{x|y}^{(k)} and Σ_{x|y}^{(k)} from the feature enhancement unit 13-1, . . . 13-M are combined by an equation (20), and μ_{x|y} and Σ_{x|y} are output.

$${μ}_{x \vert y} = {\sum }_{k} p ( k \vert y ) {μ}_{x \vert y}^{( k )} \\ {Σ}_{x \vert y} = {\sum }_{k} p ( k \vert y ) \{ {Σ}_{x \vert y}^{( k )} + ( {μ}_{x \vert y}^{( k )} - {μ}_{x \vert y} ) {( {μ}_{x \vert y}^{( k )} - {μ}_{x \vert y} )}^{T} \qquad ( 20 )$$

Next, operation of the speech recognition apparatus 10 of the second embodiment is explained by referring to FIG. 5. In FIG. 5, as to the same step in FIG. 3 of the first embodiment, the same sign is assigned and its explanation is omitted.

First, feature extraction processing of S31 and noise estimation processing of S32 are executed. Next, at S33, the Gaussian distribution calculation unit 133-k of the feature enhancement unit 13-k calculates a Gaussian parameter by the unscented transformation, and the Gaussian distribution storage unit 132-k stores the Gaussian parameter. At S34, the calculation execution unit 134-k calculates a posterior distribution parameter based on the Gaussian parameter stored in the Gaussian distribution storage unit 132-k. At S51, the speech recognition apparatus 10 decides whether processing of all feature enhancement units 13-1, . . . 13-M is completed. If processing of at least one feature enhancement unit is not completed, control is returned to S33. If processing of all feature enhancement units is completed, control is forwarded to S52.

Next, at S52, the weight calculation unit 41 calculates a combination weight. At S53, the combining unit 42 combines an output from the feature enhancement unit 13-1, . . . 13-M of M units. At S35, the comparison unit 14 compares the combined posterior distribution parameter with a standard pattern of each word. At S36, the speech recognition apparatus 10 decides whether all frames are completely processed. If at least one frame is not processed yet, next frame is processed at S31. If all frames are completely processed, at S37, the comparison unit 14 outputs a word sequence of the noisy speech based on the comparison result. As mentioned-above, in the second embodiment, the Gaussian mixture model is used. Accordingly, in comparison with a single Gaussian model, the prior distribution can be represented with higher minuteness. As a result, an effect to enhance the feature further rises and an ability to recognize a speech is further maintained in a noisy environment.

### The Third Embodiment

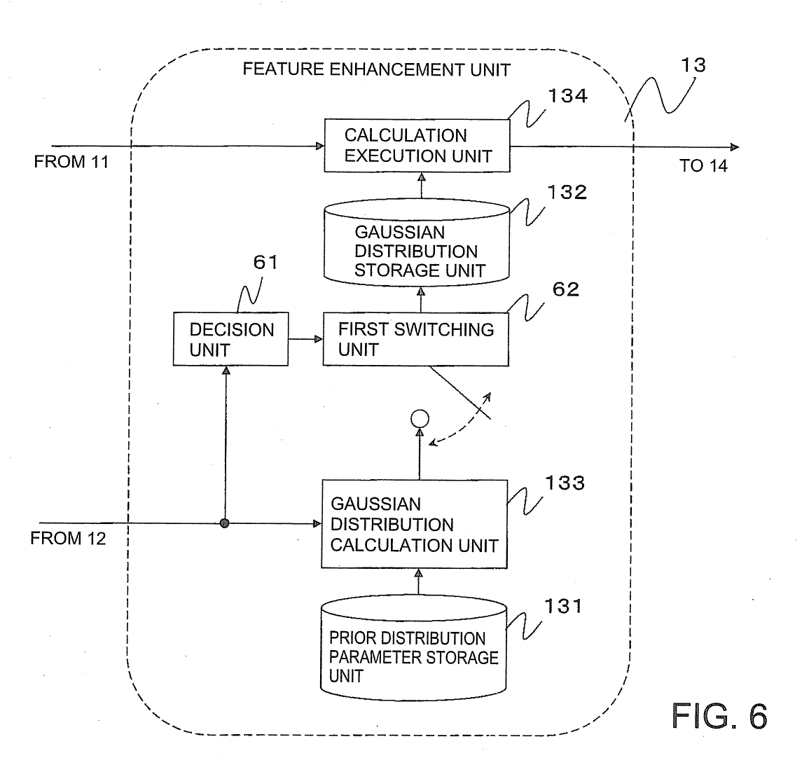

Next, the speech recognition apparatus 10 of the third embodiment is explained by referring to FIGS. 6˜8. In the first and second embodiments, the Gaussian parameter is calculated for all frames, and the calculation load is large. Accordingly, in the third embodiment, it is decided whether recalculation of the Gaussian parameter is necessary for each frame. In case of unnecessary, recalculation of the Gaussian parameter is omitted. As a result, the calculation load is reduced. In comparison with the first and second embodiments, the feature enhancement unit 13 of the third embodiment is only different, and explanation of another unit is omitted.

The feature enhancement unit 13 of the third embodiment is explained by referring to FIG. 6. FIG. 6 is a block diagram of the feature enhancement unit 13 of the third embodiment. As shown in FIG. 6, the feature enhancement unit 13 includes a prior distribution parameter storage unit 131, a Gaussian distribution storage unit 132, a Gaussian distribution calculation unit 133, a calculation execution unit 134, a decision unit 61, and a first switching unit 62. Except for the decision unit 61 and the first switching unit 62, each unit is same as that of the first and second embodiments. Accordingly, by assigning the same sign to each unit, its explanation is omitted.

The decision unit 61 is explained. The decision unit 61 decides whether recalculation of the Gaussian parameter is necessary for one frame. The decision unit 61 inputs a noise parameter of each frame from the noise estimation unit 12. When the noise parameter of a frame changes largely, the Gaussian parameter also changes largely, and it is decided that recalculation of the Gaussian parameter of the frame is necessary. Conversely, when the noise parameter of a frame does not change largely, the Gaussian parameter also does not change largely, and it is decided that recalculation of the Gaussian parameter of the frame is unnecessary.

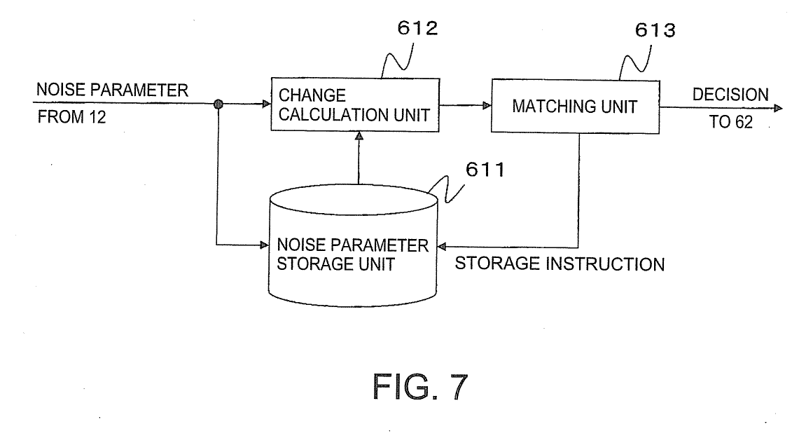

FIG. 7 is a block diagram of the decision unit 61. As shown in FIG. 7, the decision unit 61 includes a noise parameter storage unit 611, a change calculation unit 612, and a matching unit 613. First, the noise parameter storage unit 611 stores a noise parameter of a prior frame from which the Gaussian distribution calculation unit 133 has calculated the Gaussian parameter last. The change calculation unit 612 calculates a change between a noise parameter of a present frame (output from the noise estimation unit 12) and the noise parameter of the prior frame (stored in the noise parameter storage unit 611). For example, by an Euclidean distance represented as an equation (21), the change of noise parameter is calculated.

Δ=(μₙ− μ̅ₙ)² (21)

In the equation (21), “Δ” is the change of noise parameter, “μₙ” is a noise parameter of the present frame, and “ μ̅ₙ” is a noise parameter of the prior frame stored in the noise parameter storage unit 611.

The matching unit 613 compares the change with an arbitrary threshold. If the change is larger than the threshold, it is decided that the noise parameter has changed largely from timing when the Gaussian parameter has been calculated last. Accordingly, a decision result that recalculation of the Gaussian parameter is necessary is output. At the same time, the matching unit 613 sends a storage instruction to the noise parameter storage unit 611, and the noise parameter of the present frame is stored in the noise parameter storage unit 611, i.e., the noise parameter of the prior frame is updated.

If the change is smaller than the threshold, it is decided that the noise parameter has not changed largely from timing when the Gaussian parameter has been calculated last. Accordingly, a decision result that recalculation of the Gaussian parameter is unnecessary is output. In this case, the noise parameter of the prior frame stored in the noise parameter storage unit 611 is not updated.

The first switching unit 62 controls operation of the Gaussian distribution calculation unit 133 based on the decision result from the decision unit 61. Briefly, if recalculation of the Gaussian parameter is necessary, the Gaussian distribution calculation unit 133 executes recalculation, and a recalculation result (new Gaussian parameter) is stored in the Gaussian distribution storage unit 132. The calculation execution unit 134 calculates a posterior distribution parameter using the new Gaussian parameter.

On the other hand, if recalculation of the Gaussian parameter is unnecessary, the first switching unit 62 omits execution of the Gaussian distribution calculation unit 133, and content of the Gaussian distribution storage unit 132 is not updated. The calculation execution unit 134 calculates a posterior distribution parameter using the Gaussian parameter of the prior frame stored in the Gaussian distribution storage unit 132.

In case that a plurality of feature enhancement units 13-1, . . . 13-M is prepared as the second embodiment, each feature enhancement unit 13-1, . . . 13-M includes the decision unit 61. However, processing of each decision unit 61 is same. Accordingly, a single decision unit 61 can be commonly used by all feature enhancement units 13-1, . . . 13-M.

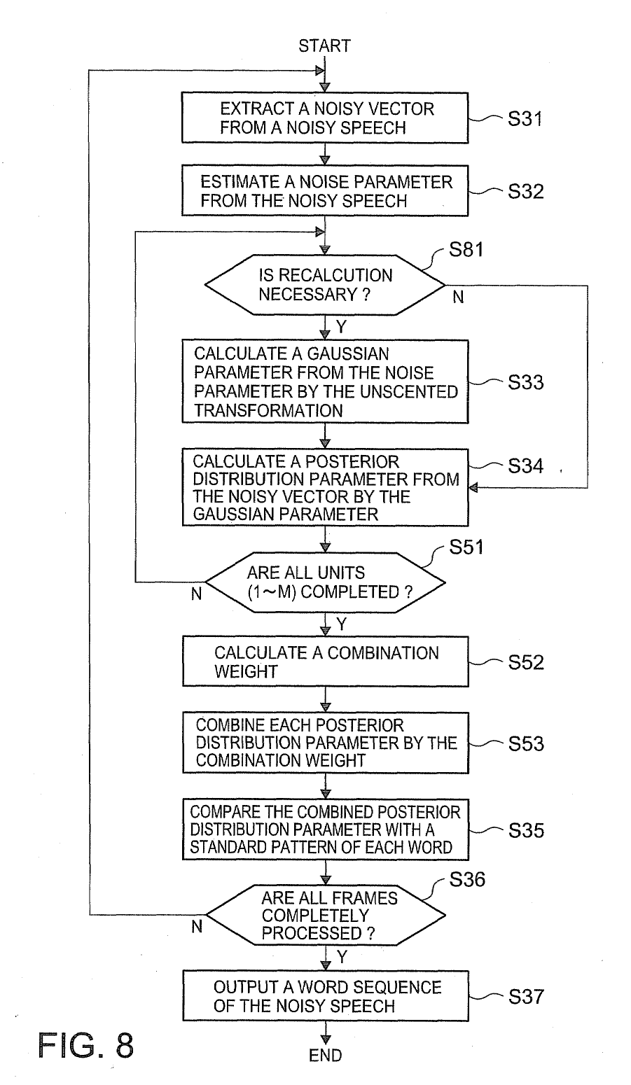

Next, operation of the speech recognition apparatus 10 of the third embodiment is explained by referring to FIG. 8. FIG. 8 is a flow chart of operation of the speech recognition apparatus 10. In this case, operation of the speech recognition apparatus 10 having a plurality of feature enhancement units 13-1, . . . 13-M is explained. Operation of the speech recognition apparatus 10 having a single feature enhancement unit 13 as the first embodiment is same as above operation, and its explanation is omitted. Furthermore, in FIG. 8, as to the same step in FIGS. 3 and 5 (the first and second embodiments), the same sign is assigned and its explanation is simplified.

First, feature extraction processing of S31 and noise estimation processing of S32 are executed. Next, at S81, the decision unit 61 decides whether recalculation of the Gaussian parameter is necessary based on the change of the noise parameter for the feature enhancement unit 13-k. If recalculation is necessary, at S33, the Gaussian distribution calculation unit 133-k calculates a Gaussian parameter by the unscented transformation. If recalculation is unnecessary, recalculation of the Gaussian parameter is omitted.

Next, at S34, the calculation execution unit 134-k calculates a posterior distribution parameter based on the Gaussian parameter stored in the Gaussian distribution storage unit 132-k. At S51, the speech recognition apparatus 10 decides whether processing of all feature enhancement units 13-1, . . . 13-M is completed. If processing of at least one feature enhancement unit is not completed, control is returned to S81. If processing of all feature enhancement units is completed, control is forwarded to S52.

Next, at S52, the weight calculation unit 41 calculates a combination weight. At S53, the combining unit 42 combines an output from the feature enhancement unit 13-1, . . . 13-M of M units. At S35, the comparison unit 14 compares the combined posterior distribution parameter with a standard pattern of each word. At S36, the speech recognition apparatus 10 decides whether all frames are completely processed. If at least one frame is not processed yet, next frame is processed at S31. If all frames are completely processed, at S37, the comparison unit 14 outputs a word sequence of the noisy speech based on the comparison result.

As mentioned-above, in the third embodiment, it is decided whether recalculation of the Gaussian parameter of each frame is necessary based on the change of the noise parameter. As to a frame which is decided that recalculation is unnecessary, execution of the Gaussian distribution calculation unit 133 is omitted. As a result, the calculation load can be reduced largely.

### The Fourth Embodiment

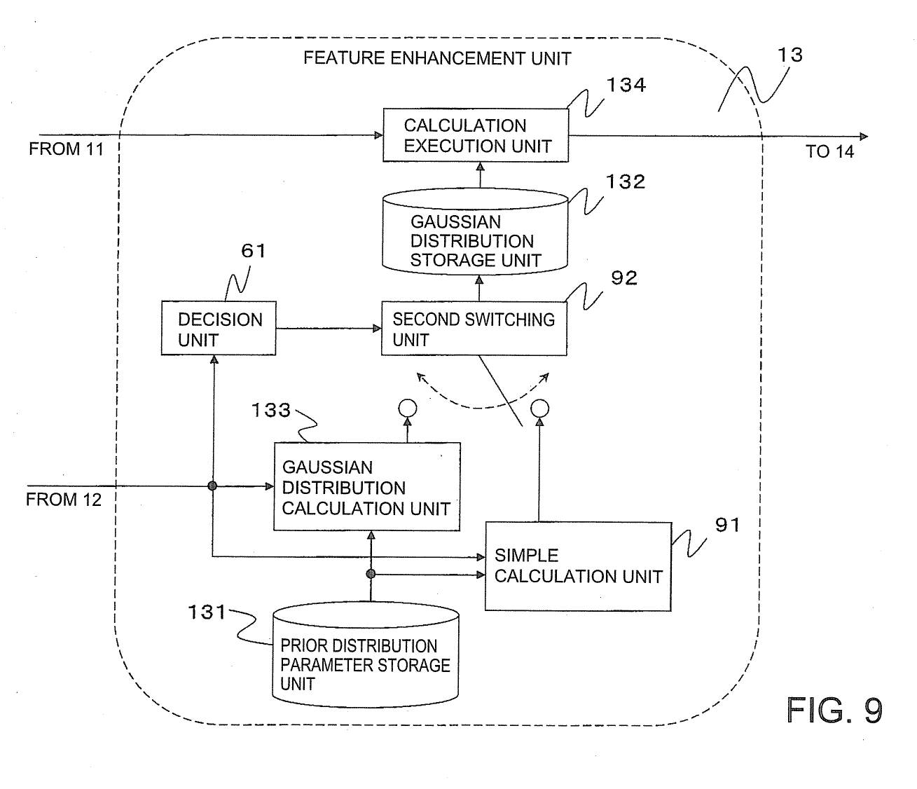

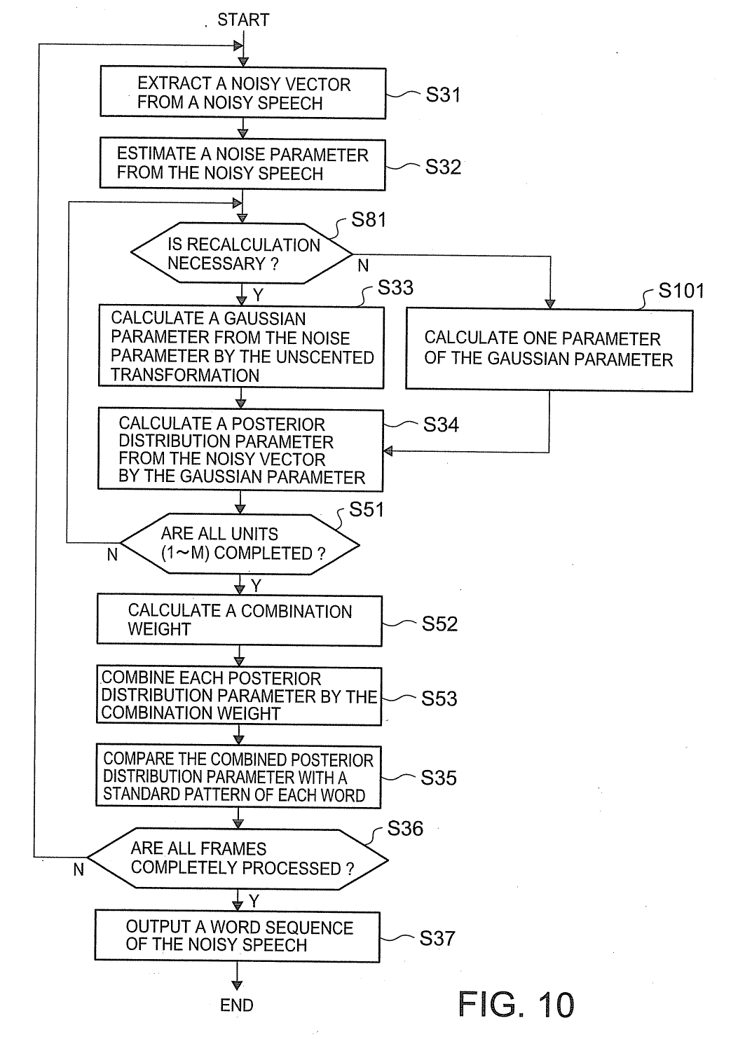

Next, the speech recognition apparatus 10 of the fourth embodiment is explained by referring to FIGS. 9 and 10. In the fourth embodiment, in the same way as the third embodiment, the calculation load of the feature enhancement unit 13 is reduced. Briefly, if the decision unit 61 decides that recalculation of the Gaussian parameter is unnecessary, a simple calculation unit 91 (calculation load is smaller than the Gaussian distribution calculation unit 133) executes recalculation of the Gaussian parameter, and at least one parameter of the Gaussian parameter is updated. The fourth embodiment is the same as the third embodiment except for the feature enhancement unit 13. Accordingly, explanation of another unit is omitted.

The feature enhancement unit 13 is explained by referring to FIG. 9. FIG. 9 is a block diagram of the feature enhancement unit 13. As shown in FIG. 9, the feature enhancement unit 13 includes a prior distribution parameter storage unit 131, a Gaussian distribution storage unit 132, a Gaussian distribution calculation unit 133, a simple calculation unit 91, a decision unit 61, a second switching unit 92, and a calculation execution unit 134. Except for the simple calculation unit 91 and the second switching unit 92, each unit is same as that of the first, second and third embodiments. Accordingly, by assigning the same sign to each unit, its explanation is omitted.

The simple calculation unit 91 updates at least one part of the Gaussian parameter by calculation load smaller than the Gaussian distribution calculation unit 133. Concretely, by using a mean μₙ as one of noise parameter (μₙ, Σₙ) of the present frame, a mean μ_{y} (one of the Gaussian parameter) of the noisy vector y is calculated by “μ_{y}=f(μₓ, μₙ)”. Another Gaussian parameter (Σ_{y}, Σ_{xy}) is not calculated.

The Gaussian parameter calculation unit 133 calculates the Gaussian parameter (μ_{y}, Σ_{y}, Σ_{xy}) by the unscented transformation. Accordingly, the parameter is calculated with a higher accuracy, but the calculation load is large. On the other hand, as to the simple calculation unit 91, the parameter is calculated with a lower accuracy, but the calculation load is small. Accordingly, based on the change of noise parameter, as to a frame decided that recalculation of the Gaussian parameter is unnecessary, by switching to the simple calculation unit 91, the calculation load of the feature enhancement unit 13 can be reduced.

Next, operation of the speech recognition apparatus 10 of the fourth embodiment is explained by referring to FIG. 10. FIG. 10 is a flow chart of operation of the speech recognition apparatus 10. In this case, operation of the speech recognition apparatus 10 having a plurality of feature enhancement units 13-1, . . . 13-M is explained. Operation of the speech recognition apparatus 10 having a single feature enhancement unit 13 as the first embodiment is same as above operation, and its explanation is omitted. Furthermore, in FIG. 10, as to the same step in FIGS. 3, 5 and 10 (the first, second and third embodiments), the same sign is assigned and its explanation is simplified.

First, feature extraction processing of S31 and noise estimation processing of S32 are executed. Next, at S81, the decision unit 61 decides whether recalculation of the Gaussian parameter is necessary based on the change of the noise parameter for the feature enhancement unit 13-k. This decision is same as the third embodiment. If recalculation is necessary, at S33, the Gaussian distribution calculation unit 133-k calculates a Gaussian parameter by the unscented transformation. If recalculation is unnecessary, at S101, the simple calculation unit 91-k calculates one parameter of the Gaussian parameter as mentioned-above.

Next, at S34, the calculation execution unit 134-k calculates a posterior distribution parameter based on the Gaussian parameter stored in the Gaussian distribution storage unit 132-k. In this case, if the simple calculation unit 91-k has calculated one parameter of the Gaussian parameter at S101, another parameter of the Gaussian parameter is read from the Gaussian distribution storage unit 132-k. Based on the one parameter and another parameter, the calculation execution unit 134-k calculates the posterior distribution parameter.

Next, at S51, the speech recognition apparatus 10 decides whether processing of all feature enhancement units 13-1, . . . 13-M is completed. If processing of at least one feature enhancement unit is not completed, control is returned to S81. If processing of all feature enhancement units is completed, control is forwarded to S52.

Next, at S52, the weight calculation unit 41 calculates a combination weight. At S53, the combining unit 42 combines an output from the feature enhancement unit 13-1, . . . 13-M of M units. At S35, the comparison unit 14 compares the combined posterior distribution parameter with a standard pattern of each word. At S36, the speech recognition apparatus 10 decides whether all frames are completely processed. If at least one frame is not processed yet, next frame is processed at S31. If all frames are completely processed, at S37, the comparison unit 14 outputs a word sequence of the noisy speech based on the comparison result.

As mentioned-above, in the fourth embodiment, it is decided whether recalculation of the Gaussian parameter of each frame is necessary based on the change of the noise parameter. As to a frame which is decided that recalculation is unnecessary, the simple calculation unit 91 to execute with a smaller calculation load is selected. As a result, the calculation load can be reduced largely.

In the disclosed embodiments, the processing can be performed by a computer program stored in a computer-readable medium.

In the embodiments, the computer readable medium may be, for example, a magnetic disk, a flexible disk, a hard disk, an optical disk (e.g., CD-ROM, CD-R, DVD), an optical magnetic disk (e.g., MD). However, any computer readable medium, which is configured to store a computer program for causing a computer to perform the processing described above, may be used.

Furthermore, based on an indication of the program installed from the memory device to the computer, OS (operation system) operating on the computer, or MW (middle ware software) such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

Other embodiments of the invention will be apparent to those skilled in the art from consideration of the specification and embodiments of the invention disclosed herein. It is intended that the specification and embodiments be considered as exemplary only, with the scope and spirit of the invention being indicated by the claims.

What is claimed is:

1. An apparatus for recognizing a speech, comprising:
a feature extraction unit configured to extract a noisy vector from a noisy speech inputted, the noisy speech being a clean speech on which a noise is superimposed;
a noise estimation unit configured to estimate a noise parameter of the noise from the noisy vector;
a parameter storage unit configured to store a prior distribution parameter of a clean vector of the clean speech;
a distribution calculation unit configured to calculate a joint Gaussian distribution parameter between the clean vector and the noisy vector by unscented transformation, from the noise parameter and the prior distribution parameter;
a calculation execution unit configured to calculate a posterior distribution parameter of the clean vector by the joint Gaussian distribution parameter, from the noisy vector; and
a comparison unit configured to compare the posterior distribution parameter with a standard pattern of each word previously stored, and output a word sequence of the noisy speech based on a comparison result.

2. The apparatus according to claim 1, wherein
the feature extraction unit extracts the noisy vector of each of frames of the noisy speech.

3. The apparatus according to claim 2, wherein
the distribution calculation unit calculates the joint Gaussian distribution parameter between the clean vector and the noisy vector in correspondence with each of the frames.

4. The apparatus according to claim 3, wherein,
when all frames of the noisy speech are completely processed,
the comparison unit outputs the word sequence of the noisy speech.

5. The apparatus according to claim 1, further comprising:
a Gaussian distribution storage unit configured to store the joint Gaussian distribution parameter of each of the frames, wherein
the calculation execution unit retrieves the joint Gaussian distribution parameter from the Gaussian distribution storage unit.

6. The apparatus according to claim 1, further comprising:
a plurality of feature enhancement units each having the parameter storage unit, the distribution calculation unit and the calculation execution unit,
a weight calculation unit configured to calculate a weight of each posterior distribution parameter based on the joint Gaussian distribution parameter calculated by each distribution calculation unit; and
a combining unit configured to combine each posterior distribution parameter with the weight, and output the combined posterior distribution parameter to the comparison unit.

7. The apparatus according to claim 5, further comprising:
a decision unit configured to calculate a change of the noise parameter of each of the frames, decide that recalculation of the joint Gaussian distribution parameter is necessary if the change is larger than a threshold, and decide that recalculation of the joint Gaussian distribution parameter is unnecessary if the change is smaller than the threshold; and
a first switching unit configured to output the joint Gaussian distribution parameter recalculated to the calculation execution unit for the frame decided to be necessary, and output the joint Gaussian distribution parameter of a prior frame stored in the Gaussian distribution storage unit to the calculation execution unit for the frame decided to be unnecessary.

8. The apparatus according to claim 5, further comprising:
a decision unit configured to calculate a change of the noise distribution parameter of each of the frames, decide that recalculation of the joint Gaussian distribution parameter is necessary if the change is larger than a threshold, and decide that recalculation of the joint Gaussian distribution parameter is unnecessary if the change is smaller than the threshold;
a simple calculation unit configured to calculate one parameter of the joint Gaussian distribution parameter from the noise distribution parameter and the prior distribution parameter; and
a second switching unit configured to output the joint Gaussian distribution parameter recalculated to the calculation execution unit for the frame decided to be necessary, and output the one parameter and the joint Gaussian distribution parameter excluding the one parameter stored in the Gaussian distribution storage unit to the calculation execution unit for the frame decided to be unnecessary.

9. A method for recognizing a speech, comprising:
storing a prior distribution parameter of a clean vector of a clean speech in a memory;
extracting a noisy vector from a noisy speech inputted, the noisy speech being the clean speech on which a noise is superimposed;
estimating a noise parameter of the noise from the noisy vector;
calculating a joint Gaussian distribution parameter between the clean vector and the noisy vector by unscented transformation, from the noise parameter and the prior distribution parameter stored in the memory;
calculating a posterior distribution parameter of the clean vector by the joint Gaussian distribution parameter, from the noisy vector;
comparing the posterior distribution parameter with a standard pattern of each word previously stored; and
outputting a word sequence of the noisy speech based on a comparison result.

10. A computer readable medium storing program codes for causing a computer to recognize a speech, the program codes comprising:
a first program code to store a prior distribution parameter of a clean vector of a clean speech in a memory;
a second program code to extract a noisy vector from a noisy speech inputted, the noisy speech being the clean speech on which a noise is superimposed;
a third program code to estimate a noise parameter of the noise from the noisy vector;
a fourth program code to calculate a joint Gaussian distribution parameter between the clean vector and the noisy vector by unscented transformation, from the noise parameter and the prior distribution parameter stored in the memory;
a fifth program code to calculate a posterior distribution parameter of the clean vector by the joint Gaussian distribution parameter, from the noisy vector;
a sixth program code to compare the posterior distribution parameter with a standard pattern of each word previously stored; and
a seventh program code to output a word sequence of the noisy speech based on a comparison result.
